(19) United States
(12) Patent Application Publication
(10) Pub. No.: US 2026/0296867 A1
(43) Pub. Date: Oct. 1, 2026

(54) CAPPING HEAD PROVIDED WITH AXIAL LOAD AND/OR TORQUE SENSORS AND CAPPING METHOD

(71) Applicant: AROL S.P.A., Canelli (AT) (IT)

(72) Inventors: Fabio PREGNO, Canelli (AT) (IT); Denis RUFFINO, Canelli (AT) (IT); Manuel SORCE, Canelli (AT) (IT); Alessandro VARESI, Canelli (AT) (IT)

(21) Appl. No.: 18/880,444

(22) PCT Filed: Jul. 7, 2023
(86) PCT No.: PCT/IB2023/057027

§ 371 Date: Dec. 31, 2024

(30) Foreign Application Priority Data
Jul. 8, 2022 (IT) 102022000014500

(51) Int. Cl. B67B 3/20

(52) U.S. Cl. CPC B67B 3/20

(57) ABSTRACT

A capping head includes a shaft performing a downward vertical translatory movement and applying an axial load to a cap, and a cap-holding cone integral with the shaft. A sensing assembly is mounted on the shaft or cap-holding cone for detecting values of at least one parameter that characterises the capping operation and communicating the values to an acquisition system for recognition of a significant phase of the capping cycle. The sensing assembly includes at least one sensor for dynamically measuring the value of the at least one parameter, telemetry circuits associated with the at least one sensor for acquiring the values measured by the sensor, processing them and transmitting the processing results to the acquisition system by using a low consumption radiofrequency technology, power supply means for the sensing assembly, possibly operating in a radiofrequency technology, and power management circuits for managing power supplied by the power supply means.

### TECHNICAL FIELD

This invention relates to capping installations and more particularly it concerns a capping head provided with sensors for measuring at least the axial load applied to a cap during capping.

The invention also concerns a capping machine and a capping method employing such a head.

### BACKGROUND ART

Capping heads are devices allowing applying a cap or closure on the mouth of containers such as bottles, vials and so on. They are usually employed inside capping assemblies or capping machines that generally comprise a mobile support moving a plurality of said heads by following a path along which the containers are conveyed. For instance, the capping heads are mounted at the periphery of a support that is made to rotate in order to sequentially bring the containers and the heads to a capping position. During displacement, the capping heads are submitted to a downward vertical translatory movement in order to reach the position of the mouth of the container to be capped and to be lifted again once capping is over. Moreover, in case of application of pre-threaded caps (or screw caps, the two terms being used here indifferently), the heads are also made to rotate to tighten the cap on the mouth of the container, and the translatory movement also serves for applying a compensation axial load (top load) necessary to keep the container blocked during capping.

During capping, it is usual practice to measure the values of a number of parameters characterising the operation, in particular the vertical force or axial load applied because of the translatory movement or, in case of pre-threaded caps, the torque and/or the axial load. Such measurements are intended both to verify the attainment of a pre-set limit value of the concerned parameter(s), in order to detect e.g. the end of the capping operation and to stop it in order not to exceed the aforesaid limit value, and to continuously monitor the value(s) of the parameter(s) during the whole operation in order to detect also the occurrence of problems, due for instance to irregularities of the cap or the container causing an anomalous behaviour of the monitored parameter(s). Monitoring is carried out by using suitable sensors transmitting the detected values to a control system of the installation.

An example of capping head for applying screw caps in which the torque is measured is disclosed in WO 2007/028509 A1. In this known head, the rotary movement is applied by a driving member to a cap-holding member through a magnetic coupling device (magnetic clutch) including a pair of coaxial rotors integral for rotation with the driving member and the cap-holding member, respectively. Such a coupling device is associated with means for detecting the axial and/or the angular relative position of the rotors, which means include magnetic force sensors and are configured for the wireless transmission of the detected data to a control unit for the determination, i.a., of the axial load and/or the torque applied to a cap. Also the supply of the electronic components of the detection means with power can take place in contactless manner. The solution disclosed in this document can be applied only to heads for applying screw caps employing a magnetic coupling between the driving member and the cap-holding member, and hence it has a limited flexibility of employ. Moreover, use of magnetic sensors entails that the measurements carried out are affected by errors due to non-quantifiable external factors, such as magnet ageing and temperature.

WO 2018/142290 A1 discloses a capping head for applying screw caps provided with sensors for measuring the torque, the compensation axial load and a number of other parameters. The sensors are mounted on a head portion that is not concerned by the rotary and translatory movements and that also carries means for processing the signals supplied by the sensors and is magnetically coupled with the movable portion. This head too suffers from the problems of complexity and measurement errors mentioned above.

EP 1 205 430 A1 discloses a capping machine with a plurality of capping heads for applying screw caps, where the heads are associated with torque sensors transmitting the measured values to a control unit in wireless manner. The kind of sensors employed is not disclosed.

WO 91/15422 discloses a capping head for applying screw caps, using torque sensors consisting of strain gauges.

U.S. Pat. No. 6,105,343 A and WO 2011/029617 A2 disclose other examples of capping heads for applying screw caps provided with sensors for detecting the values of a number of parameters, including the torque applied to a cap, in which the sensors transmit the respective data to a control unit in wireless manner. In U.S. Pat. No. 6,105,343 A the torque sensor consists of a strain gauge.

### SUMMARY OF INVENTION

In order to obviate the drawbacks of the prior art, the invention provides, in a first aspect, a capping head wherein a sensing assembly is mounted on one out of the shaft of the head and the cap-holding cone for detecting the values of at least one parameter characterising the capping operation, in particular at least the axial load, and for communicating said values to a remote acquisition system in wireless manner, more particularly as radiofrequency signals. The sensing assembly is directly applied onto the shaft or the cap-holding cone and it includes:
at least one sensor for dynamically measuring the value of the at least one parameter during capping;
telemetry circuits associated with the at least one sensor for acquiring the values measured by the sensor, processing them for their transmission to the acquisition system, and transmitting the processing results to the acquisition system, for the recognition of at least one significant phase of the capping cycle, by using a low consumption radiofrequency communication technology;
power supply means for the sensing assembly, including wired or battery-based local power supply devices or systems for the local harvesting of the power supplied by an external source; and
circuits for managing the power supplied by said power supply means.

In a first embodiment, the power supply means consist of an energy harvesting system operating in wireless manner, in particular at radiofrequency, and include at least one first power distribution antenna arranged to transfer the power supplied by the external source to the power management circuits when the sensing assembly, during the movements of the shaft, enters the emission cone of a second power distribution antenna, which is arranged in such a position that the at least one significant phase of the capping cycle occurs while the sensing assembly lies within its emission cone.

In such an embodiment, the power management circuits advantageously also include means for accumulating the received power, preferably supercapacitors.

In a second embodiment, the power supply means include batteries, so that, when the sensing assembly is mounted on the cap-holding cone, the latter can be used as a self-standing monitoring unit, independent of a specific capping head.

Preferably, the sensors are of a kind arranged to obtain the value of the at least one parameter from the measurement of cap deformations caused by such a parameter during capping, more particularly strain gauges.

Advantageously, when the values of a plurality of parameters are detected, the sensing assembly includes a sensor for each parameter and the telemetry circuits comprise spatially separated telemetry units, associated each with one sensor and arranged to establish a separate communication channel for transmitting the data concerning the respective parameter. In the alternative, a single telemetry unit could manage all sensors.

If the head is intended for applying screw caps, and hence the shaft performs also a rotary movement about its axis, the set of parameters includes at least the axial load and the torque applied to a cap because of the downward vertical translatory movement and the rotary movement about its axis of the shaft.

In a preferred embodiment, the sensing assembly is located in a prism-shaped region of the shaft or the cap-holding cone, respectively, and that region carries the sensors and the telemetry circuits associated therewith on at least one side face and carries the power management circuits on at least another side face. In case the sensing assembly is supplied with power by systems for the local harvesting the power supplied by an external source, such a prism-shaped region carries one or more first power distributing antennas on one or more further side faces.

Advantageously, each communication channel includes the advertising channels and the data channels provided for by the Bluetooth® Low Energy (BLE) specifications and the telemetry units use the advertising channels for automatically sending, during the normal operation of the head, the current values of the parameter measured by the respective sensor and use the data channels for sending, during analysis or debug phases and upon request of a control system, all detected values of said parameter.

If the capping head belongs to a capping machine with a plurality of capping heads, during normal operation the sensors of one head can transmit the current values of the measured parameter on a rotating basis with the sensors of the other heads.

In a second aspect, the invention also concerns a capping machine comprising:
at least one capping head as described above, mounted on a mobile support moving it along a path along which also the containers to be capped are conveyed;
at least one data transmitting and receiving antenna, arranged to receive the signals emitted by the sensing assembly from the at least one capping head when the head enters the reception cone of the antenna, and to forward such signals to the acquisition system; and
in case the power supply means for the sensing assembly include systems for the local harvesting of the power supplied by an external source using a radiofrequency technology, at least one second power distribution antenna, which receives the power from the external source, is arranged to transfer the power supplied by the source to the sensing assembly when the latter, during the movements of the shaft, enters its emission cone, and is located in such a position that the at least one significant phase of the capping cycle occurs while the sensing assembly lies within its emission cone.

In a further aspect, the invention also provides a capping method comprising the steps of:
applying directly onto the shaft or the cap-holding cone of a capping head a sensing assembly including at least one sensor for detecting the values of at least one parameter that characterises the capping operation and that is chosen in a set including at least the axial load applied to a cap because of a downward vertical translatory movement of the shaft;
supplying the sensing assembly with the power supplied by wired or battery-based local power supply devices or by systems for the local harvesting of the power supplied by an external source, the latter systems supplying the sensing assembly with power in wireless manner, in particular by using a radiofrequency technology;
processing the detected values for their transmission to a remote acquisition system intended for recognising at least one significant phase of the capping cycle;
establishing at least one communication channel between the sensing assembly and the acquisition system and transmitting the processing results to such a system in wireless manner, in particular as radiofrequency signals, by using a low consumption communication technology; and
on the at least one communication channel, during normal operation of the head, automatically transmitting to the acquisition system, the information relevant to the current values of the at least one parameter and, during an analysis or debug phase, transmitting to the acquisition system, upon request, all detected values of the parameter.

### BRIEF DESCRIPTION OF DRAWINGS

The above and other features and advantages of the present invention will become more apparent from the following description of preferred embodiments, made by way of non-limiting example with reference to the accompanying drawings, in which:

FIG. 1 shows a partial isometric view of a capping turret equipped with capping heads according to a first embodiment of the invention, in which the sensors are applied onto the shaft of each head;

FIG. 2 shows part of the turret of FIG. 1 in enlarged scale;

FIG. 3 is a partial cross-sectional view of the shaft equipped with the sensing assembly;

FIG. 4 is a view, taken from a first direction, showing the arrangement of the sensing assembly onto the shaft;

FIG. 5 is a view, taken from the opposite direction of FIG. 4, showing the arrangement of the sensing assembly onto the shaft;

FIG. 6 is a view similar to FIGS. 4 and 5, in which one of the telemetry boards has been removed to show one sensor;

FIG. 7 is an exemplary graph illustrating signals supplied by the sensors during a significant phase of the capping cycle in case of application of a crown cap;

FIG. 8 is an exemplary graph illustrating signals supplied by the sensors during a significant phase of the capping cycle in case of application of a screw cap;

FIG. 9 is a view similar to FIG. 2 showing a second embodiment of the invention, in which the sensors are applied onto the cap-holding cone;

FIG. 10 is a view similar to FIGS. 4 and 5 showing a first kind of cap-holding cone employed in the turret of FIG. 9;

FIG. 11 is a view similar to FIGS. 4 and 5 showing a first kind of cap-holding cone employed in the turret of FIG. 9;

FIG. 12 is a view similar to FIGS. 9 to 11 showing the second embodiment of the invention applied to a second kind of cap-holding cone;

FIG. 13 is a view similar to FIGS. 9 to 11 showing the second embodiment of the invention applied to a second kind of cap-holding cone; and

FIG. 14 is a view similar to FIGS. 9 to 11 showing the second embodiment of the invention applied to a second kind of cap-holding cone.

### DESCRIPTION OF EMBODIMENTS

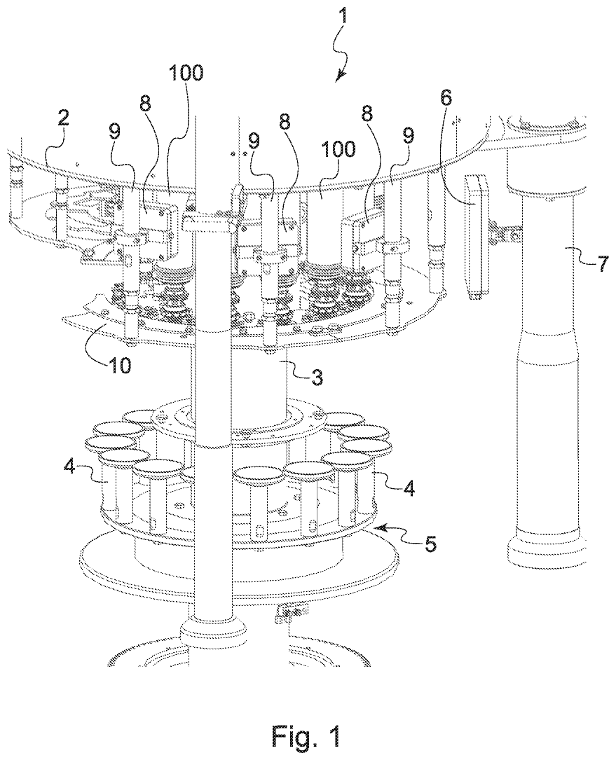

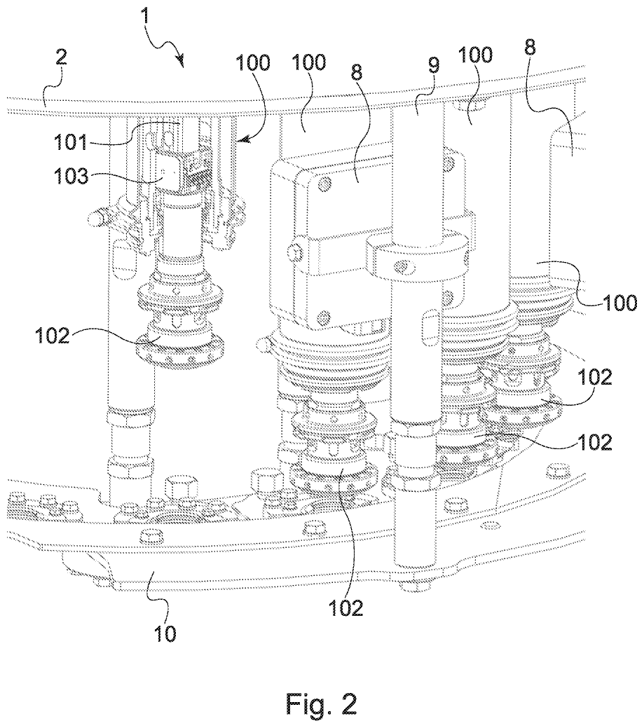

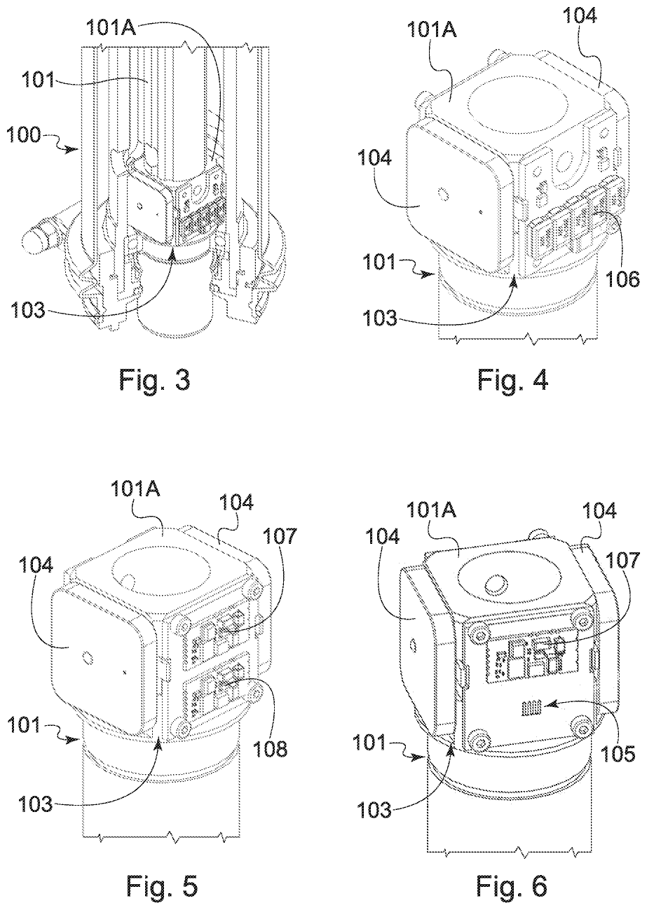

Referring to FIGS. 1 to 3, there is schematically shown a part of a rotating capping machine or turret 1 equipped with a plurality of heads 100 according to the invention for applying caps or closures on containers 4 such as bottles, vials and so on. Hereinafter, reference will be mainly made to heads for applying screw caps.

Heads 100 are carried by a supporting structure 2 that is made to rotate by a shaft 3 with vertical axis in order to take containers 4 to be capped from an input carousel 5, bring containers 4 and heads 100 to a capping position and then bring the capped containers to a position for extraction from capping machine 1. Heads 100 are mounted on supporting structure 2 with their axes parallel to the axis of shaft 3 and, in conventional manner, they can axially slide between a raised idle position and a lowered capping position and rotate about their axis in order to tighten the cap. As far as the structure of heads 100 is concerned, the only feature of interest for the invention is that they include a rotating and translating shaft 101 bearing at its lower end cap-holding cone 102 and hence the means for gripping/releasing the caps. Therefore, such a structure will not be described in detail, being moreover wholly conventional. Of course, if the caps to be applied are not screw caps, heads 100, and hence shafts 101 and cones 102, could perform the only translatory movement.

In the present invention, sensors for dynamically detecting the torque and/or the compressive load applied to shaft 101 and by the latter to cone 102 and hence to the cap are applied to shaft 101 of each head. The whole of the sensors, the electronic components for processing the values detected by the sensors and the transmission of the relevant information to a remote data acquisition system (not shown), connected to or being part of a control system, and the circuits for supplying such components with power is generally denoted by reference numeral 103 and will be hereinafter referred to as “sensing assembly”. Sensing assembly 103 is located in the lower part 101A of shaft 101, for instance in a prism-shaped, in particular parallelepiped-shaped region.

Advantageously, the torque and axial load sensors are sensors capable of detecting cap deformations caused by the torque and/or the axial load during capping, e.g. strain gauges. Strain gauges, well known in the art, allow a good measurement precision and are cost-effective components. Moreover, as known, they allow measuring a multiplicity of different quantities causing cap deformation.

In the illustrated embodiment, communication between sensing assembly 103 and the acquisition system uses a wireless technology, in particular a low consumption radiofrequency technology, for instance based on the Bluetooth® Low Energy technology. Sensing assembly 103 will transmit the radiofrequency signals towards a data transmitting and receiving antenna 6, which is carried for instance by anti-rotation column 7 and which receives the signals from the individual heads 100 and forwards them to the acquisition system.

In the illustrated embodiment, power supply for the circuits of sensing assembly 103 is obtained by means of power harvesting systems operating by means of a wireless technology, e.g. at radiofrequency. To this end, turret 1 will be associated with power distribution antennas 8, distributed along its periphery, for receiving such power from a remote power source and emitting it towards sensing assembly 103 when the head passes opposite the antenna. Antennas 8 are carried for instance by uprights 9 supporting the neck-guiding devices, which are carried by a stationary platform 10.

Using a wireless technology for data transmission by sensing assembly 103 and for supplying it with power is the preferred solution, taking into account that the concerned devices are mounted on a moving structure and hence the data transmission or power supply cables could hinder the structure movements or be damaged by such movements. Being antennas 6, 8 stationary, use of wireless technology could even concern only the path between said antennas and the sensing assembly.

Referring now to FIGS. 4 to 6, sensing assembly 103 advantageously includes a pair of power receiving antennas 104, the actual sensors 105 (one of which can be seen in FIG. 6), a board 106 for power management and accumulation and a pair of telemetry boards 107, 108 for managing the channel associated with the torque sensor and the channel associated with the axial load sensor, respectively. Antennas 104 are respectively mounted on two opposite faces of shaft portion 101A. Board 106 for power management and accumulation is mounted on one of the other two faces, and sensors 105, over which telemetry boards 107, 108 are placed, are mounted on the opposite face.

Antennas 104 transfer the power they receive through antennas 8 to board 106 for power management and accumulation, which accumulates it and distributes the accumulated power to the various circuits in telemetry boards 107, 108 depending on the respective needs. For power accumulation, board 106 advantageously includes supercapacitors, not indicated explicitly.

As far as telemetry boards 107, 108 are concerned, they contain the circuits that receive the signals from the torque and load sensors, sample them at a known rate, digitise them and transmit them as radiofrequency signals according to a suitable protocol by means of respective antennas, not indicated explicitly. Boards 107, 108 are spatially separated, e.g. located one above the other, in order to prevent, in the area where the sensors are active, superposition on a same channel of communications relevant to both sensors.

Sensors 105 of a head 100 receive power when they enter the transmission cone of the corresponding antenna 6 during the translatory or rotary-translatory movement of shaft 101. As far as the vertical position is concerned, this occurs when a cap arrives near to or at the mouth of a container 4. Given the provision of the power accumulating means in boards 106, once a short time from the start of the capping machine operation has elapsed, sensors 105 will be supplied with power during the whole of the operation of the capping machine.

The observation window defined by the permanence of a sensor within said transmission cone corresponds to a time period during which head 100 performs at least one significant phase of the capping cycle, the occurrence of which is to be recognised by the acquisition system. Such a phase can be for instance the end phase of the capping, another phase in which intervention of the control system is possibly required, for instance because a trouble has occurred, or from which information about possible wear of components can be obtained, and so on. Within such a phase, detecting the peak value of the signals supplied by the sensors can be of interest. Failure to detect a significant phase can provide information about wrong cappings.

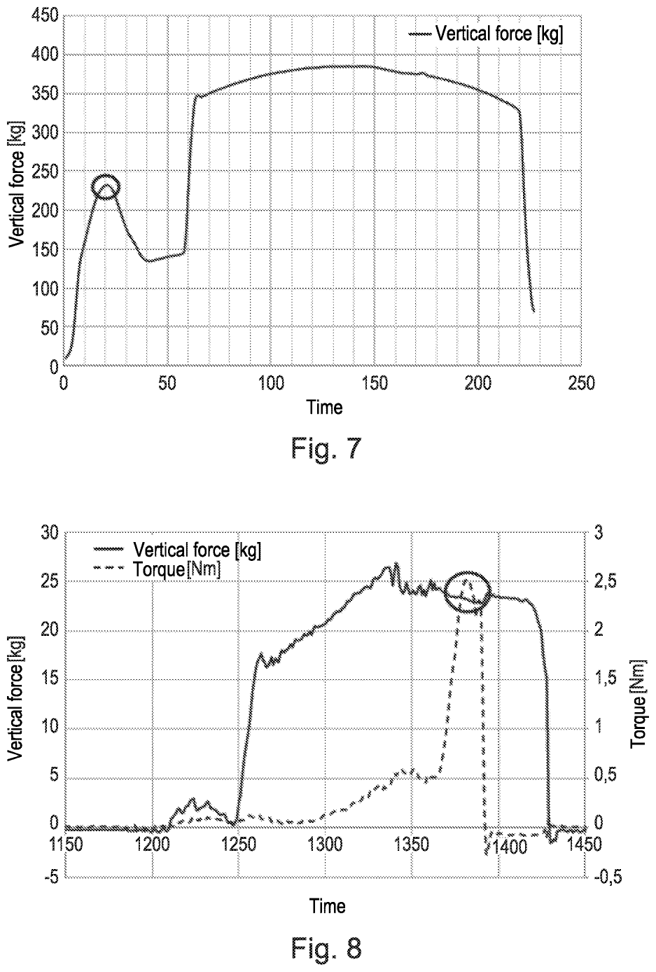

FIG. 7 shows an exemplary behaviour of the axial load in the observation window in case of application of a crown cap. In the example shown in the Figure, the value of the peak within the first part of the window (marked with a circle) can be of interest in place of the absolute maximum occurring during the second part of the window (end part of the cycle), since such a peak indicates a cap deformation that can cause closure of the same cap.

FIG. 8 shows in turn an exemplary behaviour of the axial load (solid line) and the torque (dashed line) in the observation window in case of application of a pre-threaded cap. In this case, the maximum value of the torque and the corresponding value of the axial load (marked with circles) can be of interest. In the example, the maximum value of the torque occurs when the capping phase has ended and the cap is completely screwed.

As far as data transmission towards antenna 6 is concerned, a protocol is used that is based on the Bluetooth® Low Energy specifications, used however in a peculiar manner. More particularly, according to the invention, the so-called “advertising channels”—which, according to such specifications, are only intended for the recognition by a central (master) unit of the peripheral (slave) units that can become connected to the master unit and the association of the recognised units with the master unit and which operate in broadcast modality—are used also for automatically sending, during the normal operation of head 100, the current data of the torque and the vertical force obtained by extrapolating the values detected by sensors 105. Such data will be associated with an identifier of the sensor having generated them. The data channel, operating in point-to-point modality is instead used for sending, upon request, all data pertaining to a given sensor 105 for analysis or debug purposes.

Such a choice also takes into account that the advertising channels have high energy efficiency but low capacity, and hence they are suitable for frequently sending limited amounts of information, such as the information represented by the current data. On the contrary, the data channels allow a higher data flow at the cost of a higher energy consumption and hence they are convenient for the occasional transmission of relatively bulky amounts of data, such as the data to be transmitted during an analysis or debug phase.

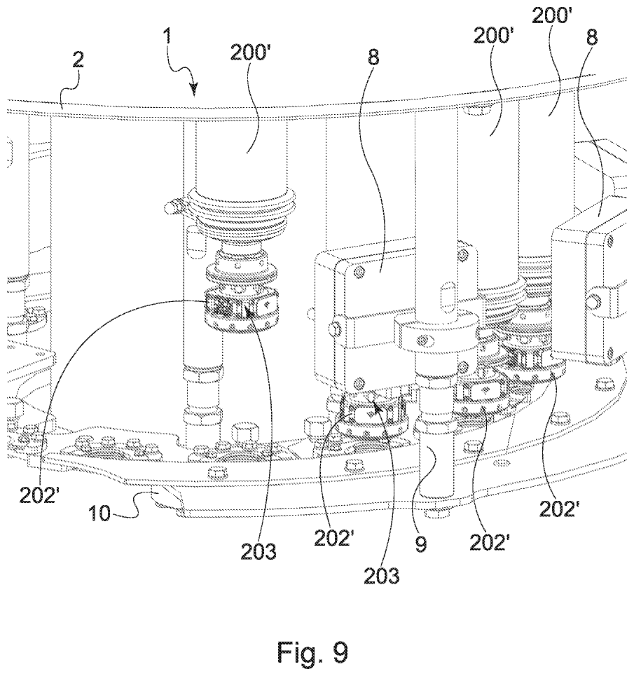

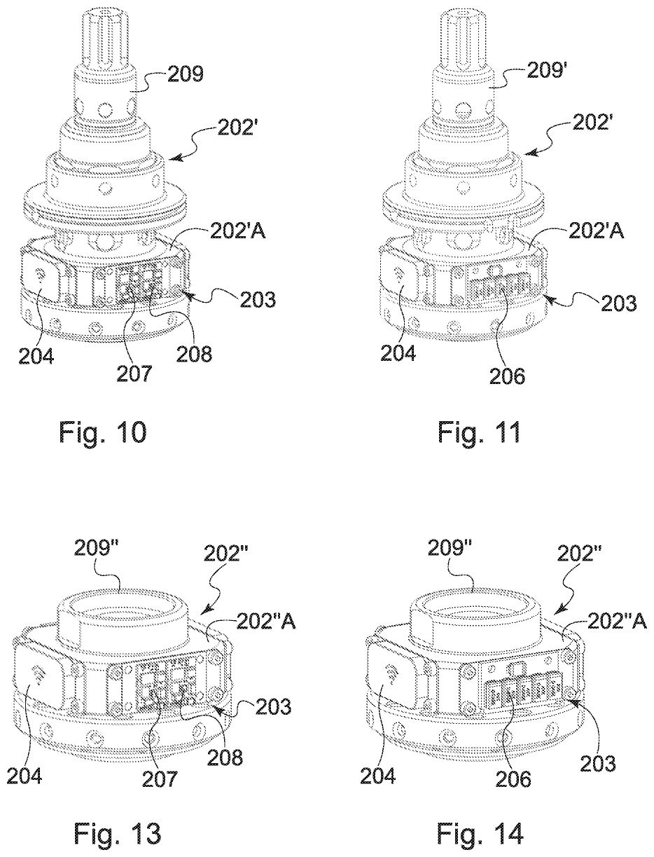

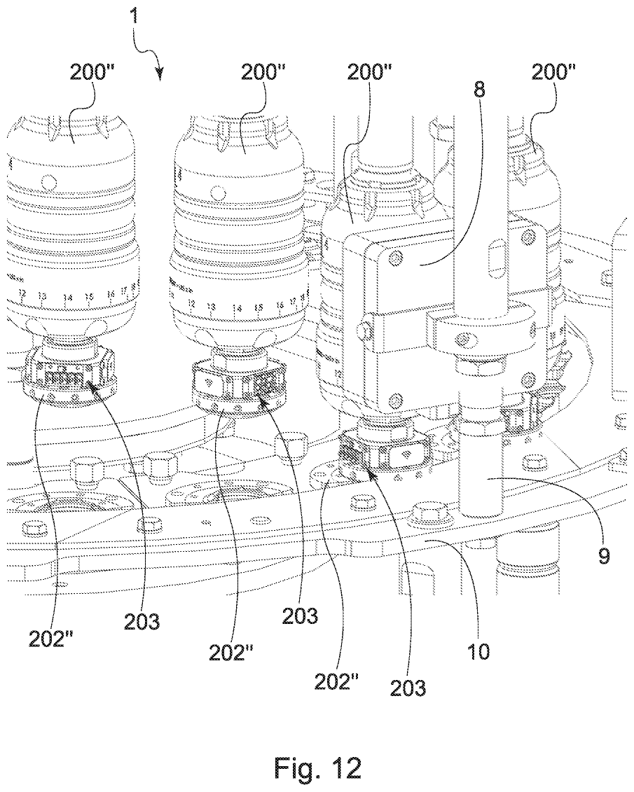

Referring now to FIGS. 9 to 14, a second embodiment of the invention is shown, in which the sensors are mounted on the cap-holding cone instead of the rotating and translating shaft. In these Figures, the heads and their parts concerned by the invention are denoted by reference numerals corresponding to the ones used in the previous Figures, yet beginning with digit 2. For the sake of simplicity, only the differences with respect to the first embodiment will be described hereinafter. The invention can be used both in case of rapid release cones 202′ with external ejector and electronic capping axle (FIGS. 9 to 11) and in case of screwed cones 202″ with internal ejector and mechanical capping axle (FIGS. 12 to 14). The structural differences between the two kinds of cones 202′, 202″ (and the two kinds of heads 200′, 200″) visible in the Figures are not of interest for the invention and therefore they will not be described in detail. In case of identical elements in both cases, the primes will be omitted.

Similarly to shaft 101 in the first embodiment, cones 202′, 202″ have a prism-shaped, in particular parallelepiped-shaped region 202′A, 202″A, located immediately below portions 209′, 209″ intended for the coupling with the rotating and translating shaft (not shown), and the components of sensing assembly 203, which is identical for both kinds of cone, are applied to the faces of that region. As in the first embodiment, sensing assembly 203 includes power-receiving antennas 204, board 206 for power management and accumulation and telemetry boards 207, 208 with the respective antennas, as well as the strain gauges under boards 207, 208. The arrangement of the components is substantially the same as in the first embodiment, except that telemetry boards 207, 208 are arranged side by side instead of one above the other, in order to keep the vertical extension of cones 202′, 202″ limited. Also the modalities of data transmission by sensing assembly 203 are identical to the ones disclosed in connection with the first embodiment.

The invention actually solves the problems of the prior art. Actually, mounting the sensing assembly directly on the shaft or the cap-holding cone instead of the coupling device results in the invention being applicable to any kind of capping head, and not only to a capping head for applying pre-threaded caps, and being independent of the kind of coupling. The invention has therefore a high flexibility of use. Moreover, the sensing assembly used in the invention is an electronic assembly and it does not use magnetic components, so that it is insensitive (or at least very scarcely sensitive) to the non-quantifiable external factors mentioned above (that is, magnet ageing and temperature), what allows a greater measurement precision.

It is clear that the above description is given only by way or non-limiting example and that changes and modifications are possible without departing from the scope of the invention as defined in the appended claims.

More particularly, a radiofrequency power supply of the sensing assemblies has been assumed for both embodiments. Yet, a wired or battery-based local power supply can also be employed. In this case, the batteries are mounted on shaft 101 or cone 202′, 202″, respectively, in place of antennas 104, 204. Use of batteries, even rechargeable batteries, is in principle less preferable than the other solutions since it can give rise to the need of stopping the installation operation in order to replace or recharge them. Yet, in case of sensors mounted on the cap-holding cone, taking into account that the cones are elements interchangeable depending on the kind of cap, supplying power by means of batteries results in the cone being also utilisable as an independent diagnostic tool, not permanently bound to a specific head or turret. Of course, in case of battery-based power supply, turret 1 will lack antennas 8 and the accumulation functions will not be required of boards 106, 206.

Moreover, even if a single antenna 6 for receiving the signals transmitted by the sensing assemblies and forwarding them to the acquisition system has been shown in the drawings, a plurality of antennas 6 distributed along the path of the heads could be provided, in order the acquisition system receives information from each head several times during each rotation cycle of the turret and not only when the data transmission antennas of a sensing assembly are substantially aligned with the single antenna 6.

Furthermore, for the data transmission by the sensing assembly to antenna 6, in place of a protocol based on the Bluetooth® Low Energy technology, other low consumption radiofrequency technologies, well known to the skilled in the art, suitable for the distances involved in a capping installation could also be used. Examples of alternative technologies are DECT-ULE (Digital Enhanced Cordless Telecommunications-Ultra Low Energy), UWB (Ultra Wide Band), Wi-Fi, Zigbee, ANT. A protocol according to which the current values of the measured parameter are transmitted on a rotating basis by the sensors of the various heads by means of point-to-point connections could also be used.

Still further, even if a head in which the sensors are applied on a single face of a parallelepiped-shaped region of the shaft or the cone has been shown, the region where the sensors are applied could have the shape of a prism with more than four faces, for instance six faces, and the sensors could be provided on more than one face. This may be useful or necessary above all when further parameters are also measured, in order to ensure a sensor positioning capable of optimising detection. In this respect, even if a telemetry board for each sensor has been provided in the described example, it is also conceivable that a single board manages a plurality of sensors or even all sensors. Of course, the protocol for communication with the acquisition system should ensure that no interference among the communications relevant to the different sensors occurs.

Lastly, even if a rotating capping machine with a plurality of heads has been shown, of course the invention could be applied even in case of a capping machine where the heads move along a rectilinear path or in case of a capping machine with a single head.

1. A capping head (100; 200′; 200″), including a shaft (101) performing a downward vertical translatory movement and applying an axial load to a cap, and a cap-holding cone (102; 202′; 202″) integral with the shaft (101), wherein a sensing assembly (103; 203) is mounted on one out of the shaft (101) and the cap-holding cone (102; 202′; 202″) for detecting the values of at least one parameter that characterises the capping operation and is chosen in a set including at least said axial load, and for communicating said values to an acquisition system, characterised in that the sensing assembly (103; 203) includes:
at least one sensor (105) for dynamically measuring the value of the at least one parameter during capping;
radiofrequency telemetry circuits (107, 108; 207, 208) associated with the at least one sensor (105) for acquiring the values measured by the sensor, processing them for their transmission to the acquisition system and transmitting the processing results to the acquisition system, for the recognition of at least one significant phase of the capping cycle, through at least one communication channel by using a low consumption radiofrequency technology;
power supply means (104; 204) for the sensing assembly (103; 203), including wired or battery-based local power supply devices or systems for the local harvesting of the power supplied by an external source; and
power management circuits (106, 206) for managing the power supplied by the power supply means (104; 204).

2. The capping head (100; 200′; 200″) according to claim 1, wherein the sensing assembly (103; 203) is directly applied onto the shaft (101) or the cap-holding cone (102; 202′; 202″).

3. The capping head (100; 200′; 200″) according to claim 1, wherein the power supply means (104; 204) for the sensing assembly (103;

203) are systems for local power harvesting operating at radiofrequency, which include at least one first power distribution antenna (104; 204) arranged to transfer the power supplied by the external source to the power management circuits (106, 206) when the sensing assembly (103; 203), during the movements or the shaft (101), enters the emission cone or a second power distribution antenna (8), which is arranged in such a position that the at least one significant phase of the capping cycle occurs while the sensing assembly (103; 203) lies within its emission cone, and the power management circuits (106, 206) include means for accumulating the received power.

4. The capping head (100; 200′; 200″) according to claim 3, wherein the power accumulating means include supercapacitors.

5. The capping head (100; 200′; 200″) according to claim 1, wherein the power supply means (204) include batteries so that, when the sensing assembly (203) is mounted on the cap-holding cone (202′; 202″), the latter can form a self-standing monitoring unit, independent or a specific capping head (200′; 200″).

6. The capping head (100; 200′; 200″) according to claim 1, wherein the at least one sensor (105) is arranged to obtain the values or the at least one parameter from the measurement or cap deformations caused by such a parameter during capping.

7. The capping head (100; 200′; 200″) according to claim 1, wherein the capping head (100; 200′; 200″) is intended for applying threaded caps, the shaft (101) performs also a rotary movement about its axis and the set or parameters includes at least the torque and the axial load applied to a cap.

8. The capping head (100; 200′; 200″) according to claim 1, wherein the values of a plurality of parameters are detected, the sensing assembly (103; 203) includes a sensor (105) for each parameter and the telemetry circuits comprise either spatially separated telemetry units (107, 108; 207, 208) associated each with one sensor and arranged to establish a separate communication channel for transmitting the data concerning the respective parameter, or a single telemetry unit managing all sensors.

9. The capping head (100; 200′; 200″) according to claim 1, wherein the sensing assembly (103; 203) is located in a prism-shaped region of the shaft (101) or the cap-holding cone (102; 202′; 202″), respectively, and that region carries the sensors (105) and the telemetry circuits (107, 108; 207, 208) associated therewith on one or more side faces and carries the power management circuits (106, 206) on one or more other side faces, and, in case the sensing assembly (103; 203) is supplied with power by systems for the local harvesting of the power supplied by an external source, that region carries one or more first power distributing antennas (104; 204) on one or more further side faces.

10. The capping head (100; 200′; 200″) according to claim 1, wherein the or each communication channel includes the advertising channels and the data channels provided for by the Bluetooth® Low Energy specifications and, during normal operation of the head (100; 200′; 200″), the telemetry unit(s) (107, 108; 207, 208) use(s) the advertising channels for automatically sending the current values of the parameter measured by the respective sensor and, during analysis or debug phases, use(s) the data channels for sending, upon request of a control system, all detected values of said parameter.

11. The capping head (100; 200′; 200″) according to claim 1, belonging to a capping machine (1) with a plurality of heads (100; 200′; 200″), wherein, during normal operation of the capping machine (1), the sensors of each head (100; 200′; 200″) transmit the current values of the measured parameter on a rotating basis with the sensors of the other heads.

12. : A capping machine (1), comprising:
at least one capping head (100; 200′; 200″) according to claim 1, mounted on a mobile support (2) moving it along a path along which also the containers (4) to be capped are conveyed;
at least one data transmitting and receiving antenna (6), arranged to receive from the at least one capping head (100; 200′; 200″) the radiofrequency signals emitted by the sensing assembly (103; 203) when the head (100; 200′; 200″) enters the reception cone of the antenna (6), and to forward such signals to the acquisition system; and
in case the power supply means (104; 204) for the sensing assembly (103; 203) are systems for the local harvesting of the power supplied by an external source operating by means or a radiofrequency technology, at least one power distribution antenna (8), which receives the power from the external source, is arranged to transfer the power supplied by the external source to the sensing assembly (103; 203) when the latter, during the movements of the shaft (101), enters its emission cone, and is arranged in such a position that the at least one significant phase of the capping cycle occurs while the sensing assembly (103; 203) lies within said emission cone.

13. The capping machine (1) according to claim 12, wherein the at least one data transmitting and receiving antenna (6) and the at least one power distribution antenna (8) are associated with stationary parts of the machine (1), and the data transfer and the power distribution by means of a radiofrequency technology take place only over the path between the sensing assembly (103; 203) and the antennas (6, 8).

14. A capping method, comprising the steps or of:
applying onto the shaft (101) or the cap-holding cone (102; 202′; 202″) of a capping head (100; 200′; 200″) a sensing assembly (103; 203) including at least one sensor (105) for dynamically detecting the values of at least one parameter that characterises the capping operation and is chosen in a set including at least the axial load applied to a cap because or a vertical downward translatory movement or the shaft (101);
supplying the sensing assembly (103; 203) with the power supplied by wired or battery-based local power supply devices or by systems for the local harvesting of the power supplied by an external source, the latter systems supplying the sensing assembly (103; 203) with power by using a wireless technology, preferably a radiofrequency technology;
processing the detected values for their transmission to a remote acquisition system intended for recognising at least one significant phase of the capping cycle;
establishing at least one communication channel between the sensing assembly (103; 203) and the remote acquisition system in order to transmit the processing results to such a system by using a low consumption radiofrequency technology; and
on the or each communication channel, automatically transmitting to the acquisition system, during normal operation of the head (100; 200′; 200″), the information relevant to the current values of the concerned parameter and, during an analysis or debug phase, transmitting all detected values of the parameter upon request of a control system.

15. The capping method according to claim 14, wherein the transmission of the processing results to the remote acquisition system by means of a low consumption radiofrequency communication technology concerns only a portion of the at least one communication channel extending inside a capping machine (1) the capping head (100; 200′; 200″) belongs to.

16. The capping method according to claim 14, wherein, for capping a container by means of pre-threaded caps, the step of applying a sensing assembly (103; 203) onto the shaft (101) or the cap-holding cone (102; 202′; 202″) includes applying a sensing assembly (103; 203) including at least a sensor for dynamically measuring the value of the axial load applied to a cap because of a vertical downward translatory movement of the shaft (101) and a sensor for dynamically measuring the value of the torque applied to the cap because of a rotary movement of the shaft (101) about its axis.

17. The capping method according to claim 14, wherein the step of establishing at least one communication channel with the acquisition system includes using, for the communication, the advertising channels and the data channels provided for by the Bluetooth® Low Energy specifications, for the automatic transmission of the current values of the at least one parameter and the transmission, upon request, of all detected values of said parameter, respectively.

18. The capping method according to claim 14, wherein the step of establishing at least one communication channel with the acquisition system includes using, for the communication, a technology chosen among DECT-ULE, UWB, Wi-Fi, Zigbee, ANT.

19. The capping method according to claim 14, wherein the method is implemented in a capping machine (1) with a plurality of heads (100; 200′; 200″), and the step of automatically transmitting to the acquisition system, during the normal operation of the head (100; 200′; 200″), the information relevant to the current values of a parameter provides for the sensors of each head (100; 200′; 200″) transmitting such information on a rotating basis with the sensors of the other heads by means of point-to-point communication channels.
